(19) United States
(12) Patent Application Publication
(10) Pub. No.: US 2010/0042968 A1
(43) Pub. Date: Feb. 18, 2010

(54) Method for software cost estimating using scope champions

(75) Inventor: Yegor Bugayenko, Naples, FL (US)

Correspondence Address: Technopark Corporation, 568 Ninth Street South 202, Naples, FL, 34102, US

(73) Assignee: TECHNOPARK CORPORATION, Naples, FL (US)

(21) Appl. No.: 12/193,010

(22) Filed: Aug. 17, 2008

(51) Int. Cl. G06F 9/44

(52) U.S. Cl. 717/101

(57) ABSTRACT

The invented method is based on the assumption that the product scope of software is defined by a complete set of requirements on the same level of abstraction. Based on this assumption, a limited number, up to seven, requirements (scope champions) are estimated using one of the existing estimating approaches. The average of the obtained estimates is multiplied by a total amount of requirements and by a constant. The result is the final product scope estimate.

### 1 BACKGROUND OF THE INVENTION

### Field of the invention

The present invention relates generally to software development projects, and to methods and systems of software development, project cost and size estimating.

Any project needs estimates (cost, time and resource) as key documents, which are based on scope definition [12].

There are many well-established and proven methods of software size and cost estimating, which are based on software specifications and organizational assets, e.g. historical data. In a general case, any method includes a) requirements analysis, b) numbers deriving and c) final calculation.

These three steps could be repeated several times iteratively, e.g. like in Wideband Delphi [3]. Each step may be completed manually or with special tools and algorithm, e.g. function point analysis [18], COCOMO [9], PERT [12], XP user stories [2, 7], SLOC prediction [1], by analogies [34], with use case points [29], class points [21], neural networks, and others.

No matter what tools and algorithms are used, the whole process has two significant disadvantages, which very often make it difficult to achieve optimal results or even to finish the estimating in time.

First, even a mid-size software project may contain hundreds of functional and non-functional requirements [16]. The time required by estimators for proper understanding and analysis of the requirements almost always is much bigger than the budgeted time for the whole estimating process. The obvious outcome of this situation is a limited understanding of requirements by estimators, which leads to inaccuracy in the estimators' judgement [28, pp. 33-54].

Second, estimators tend to approximate the numbers. With a big amount of small estimates, this leads to a certain deviation in the final calculation (either to the higher or to the lower boundary of the approximation). The deviation grows much faster than the amount of the estimates does.

A good solution to the outlined problems could be a method that will reduce the amount of efforts required for deriving numbers, at the same time improving the accuracy of the estimate.

Relevant readings: [21, 32, 35, 5, 26, 30].

### 2 BRIEF SUMMARY OF THE INVENTION

The purpose of this invention is to improve the accuracy of existing software estimating methods by decreasing the amount of efforts required for the estimating process and focusing on selected elements of the scope.

In properly managed software projects, product scope is defined by software requirements specification (SRS) [16], that includes functional and non-functional requirements to the product. A numbered list of requirements defines the boundary of the product scope, while non-functional requirements supplement them with quality attributes [37, 7].

The method consists of three steps: a) select scope champions (up to seven), b) estimate scope champions, and c) calculate the product scope estimate.

Scope champion is a selected functional requirement, the biggest and the most complex element of scope, according to the estimators' expert judgement. Scope champions are picked up from a complete set of requirements on the same level of abstraction.

When scope champions are selected, isolated estimates for them are made by estimators. Using the estimates and the formula, proposed as part of this invention, the final product scope estimate is calculated. The formula is:

$$Y \approx 0.56 \times \frac{n}{m} \times {\sum }_{i = 1}^{m} {Y}_{i} \qquad ( 1 )$$

Where {Y₁, Y₂, . . . , Yₘ} are estimates of scope champions, m is a total amount of scope champions, and n is the total amount of functional requirements in SRS. Y is a final product scope estimate.

Accuracy of the final estimate is improved because a) the estimators judgement is based on more detailed analysis, and b) the final estimate is much easier to validate and review.

The method can be used with other scope-defining artifacts, i.e. use case models [7], software architecture [17], design model [14], test plan [15], and others. The results obtained should be applied together, which will give higher accuracy for the total.

### 3 BRIEF DESCRIPTION OF THE DRAWINGS

FIG. 1 is a method flow chart, listing key steps in the method;

FIG. 2 is a sample description of product scope, in textual format;

FIG. 3 is a list of actors in a sample product scope;

FIG. 4 is a list of features (high-level functional requirements) in a sample product scope;

FIG. 5 graphically illustrates the allocation of functional requirements on different levels of abstraction;

FIG. 6 contains a sample list of functional requirements and their three-point estimates;

FIG. 7 contains a short list of requirements, that includes one scope champion;

FIG. 8 graphically illustrates requirements allocation on the same level of abstraction;

FIG. 9 has a UML diagram of classes, required for one scope champion implementation;

FIG. 10 contains an example of a detailed estimate of one scope champion;

FIG. 11 illustrates the nature of estimates, as random numbers;

FIG. 12 illustrates probability distribution of total product scope estimate;

FIG. 13 is a visual experimental selection of constant.

### 4 DETAILED DESCRIPTION OF DRAWINGS

While this invention is susceptible of embodiment in many different forms, there are shown in the drawing, and will be described herein in detail, specific embodiments thereof with the understanding that the present disclosure is to be considered as an exemplification of the principles of the invention and is not intended to limit the invention to the specific embodiments illustrated.

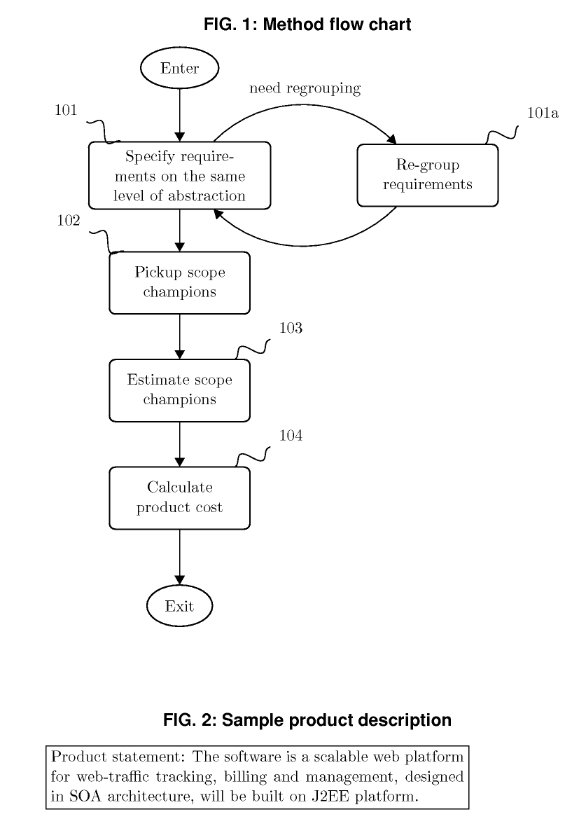

FIG. 1 illustrates a workflow of the method, starting from specified requirements and finishing with estimated product cost. In a step 101 requirements are defined by system analysis and listed in SRS document [11, 16].

In step 101a requirements shall be refined and re-grouped in order to achieve one level of abstraction allocated to all of them. The re-grouping should be performed manually with expert judgement and may involve either decomposition or aggregation of existing requirements.

During 102 scope champions are picked up from the full list of requirements. Scope champions are the most complex and ‘expensive’ requirements, according to current expert judgement. Less than seven scope champions are selected, disregarding the size of the project and total amount of functional requirements.

Step 103 estimates scope champions with one of the available estimating methods (three-point [12], function points [18], expert, parametrized, by analogy [34], etc.) The time spent for this estimating will fit almost any possible budget, since the amount of scope champions is small (less than seven).

FIG. 2 is a sample product description in format of a one-sentence statement, as recommended by RUP [11].

The system, reviewed together with this invention, is not a live system, but a test model. However, the data used in examples are partly taken from different commercial products that were developed by the author.

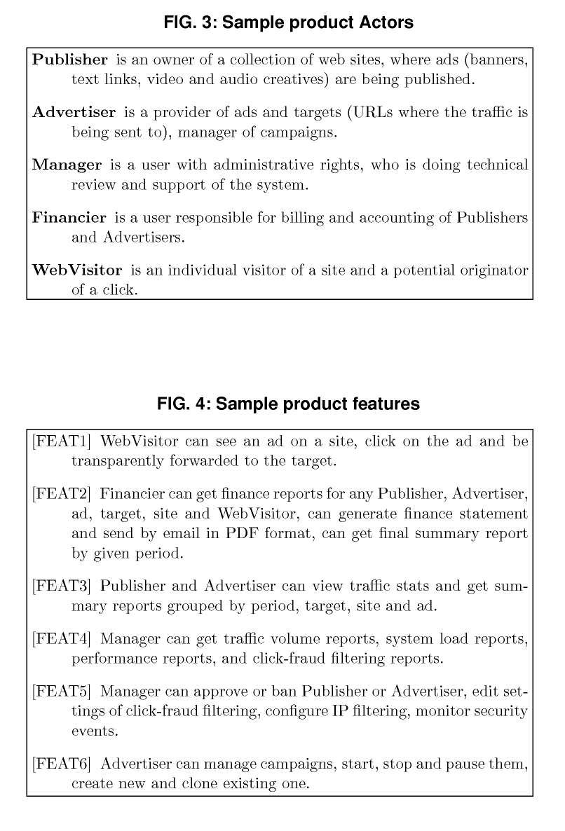

FIG. 3 lists product Actors that interact with the system. Actors are the users of the system [6], while features are contracts between Actors and the system [37].

FIG. 4 lists product features which are the most important functional requirements of the system. Features are interaction contracts between an actor and the system [37, 6, 7].

This list covers the whole scope of the system under development staying on the highest level of abstraction.

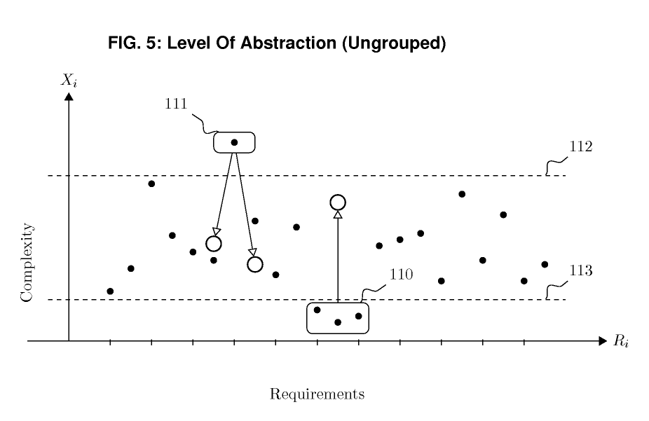

FIG. 5 illustrates a concept of one level of abstraction for all requirements in the SRS. Complexity of requirements is on the vertical axis, while horizontal dashed lines 112 and 113 separate the abstraction as minimum and maximum barriers. Small black points are functional requirements. The complexity is somewhere between minimum (113) and maximum (112) for the given project and the given level of abstraction.

The requirements which are located over the maximum (for example, 111) should be decomposed into smaller requirements.

The requirements which are located below the minimum (for example, 110) should be grouped together in order to form a new requirement replacing the existing small ones.

Such a regrouping procedure shall be repeated by system analysts as many times as necessary until all functional requirements are located on the same level of abstraction. Expert judgement is the most suitable tool in this process.

In organizations with high software development process maturity [4] the requirements are developed on one level of abstraction as a rule. In such organizations, the regrouping process (101a) could be done in the form of peer review [13, 36].

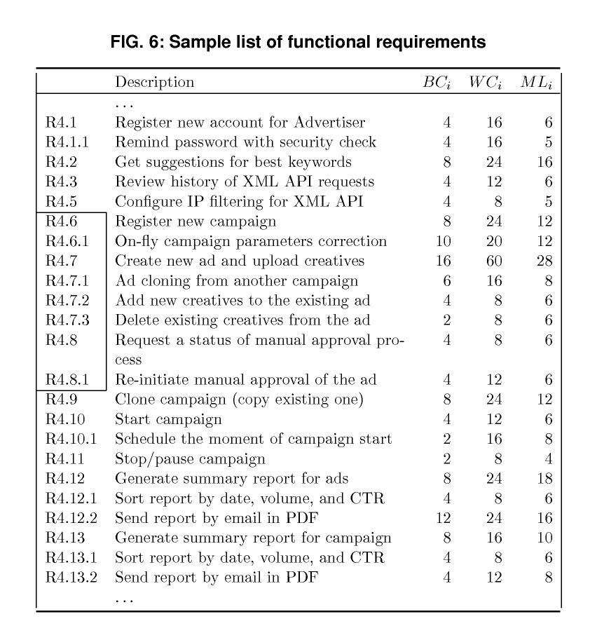

FIG. 6 illustrates an example of a small sample of functional requirements to the system. Totally there should be over 200 functional requirements, and they all are on the same level of abstraction.

The table shows the unique id of the requirement, a very short description and an example of a three point estimate for each requirement. BCᵢ stands for “best case”, WCᵢ for “worst case” and MLᵢ for “most likely” [12].

The estimates provided are only for programming activities. Design, architecture, project management, deployment and manual/system testing activities are not estimated. It is recommended to estimate all such activities with the same method, where the role of scope definition will play software architecture document (SAD), software design description (SDD), test plan or deployment plan. All estimates on the FIG. 6 and, in all other texts, are provided in staff-hours.

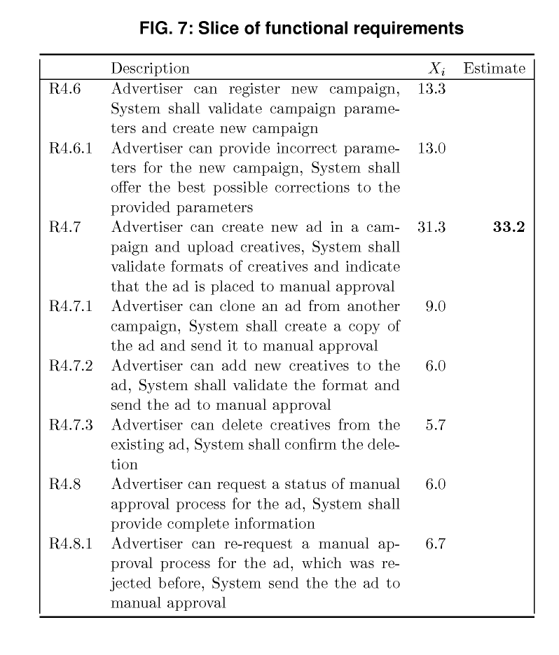

FIG. 7 illustrates an example details of eight selected estimates and the Xᵢ calculation for them (according to data from FIG. 6). Xᵢ is calculated like:

$${X}_{i} = \frac{{BC}_{i} + {WC}_{i} + {ML}_{i} \times 4}{6}$$

The estimates are only sample estimates of programming efforts required to implement the functional requirements, and do not include architecture, design, system/manual testing and deployment. Estimates are in staff-hours.

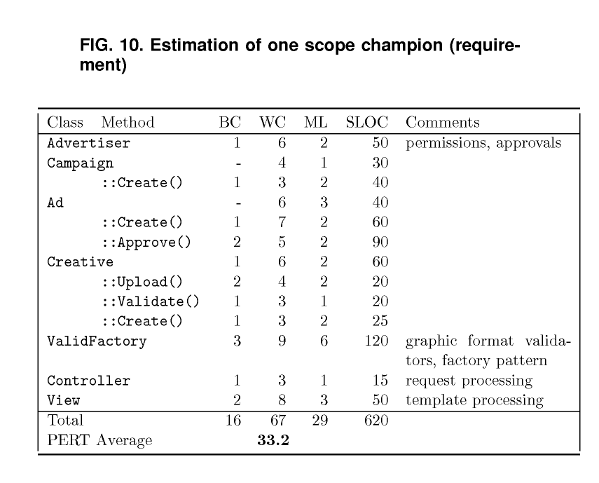

Column “Estimate” includes only one number, which is taken from a detailed estimate of scope champion R4.7 at FIG. 10.

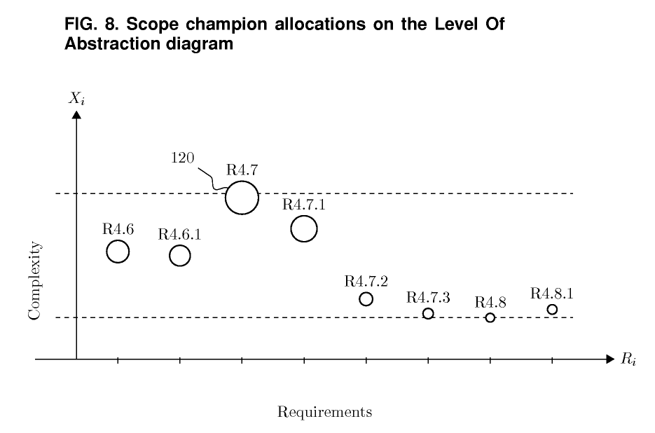

FIG. 8 illustrates the allocation of functional requirements and their relative complexities. The selection of a scope champion (R4.7, 120) is done by expert judgement. The system analyst shall select a number of the most complex requirements. These requirements are called “scope champions”.

The level of abstraction is an informally defined narrow range of sizes of functional requirements within SRS. All functional requirements stay in this range. In other words, if there are 400 functional requirements and the average amount of staff-hours required to implement any of them is 10 staff-hours, the range should be equal to 6-14 staff-hours. Requirements that are smaller or bigger than this range should be taken as located on different level of abstraction.

The definition of level of abstraction is very informal, since the scope is not estimated and there is no accurate information about the size of functional requirements. The best approach is an expert analysis of requirements in order to keep them on one level of abstraction.

Formal approach to requirements engineering, based on predicate logic will help in requirements analysis [10, 19, 8, 24, 27, 25, 20, 22].

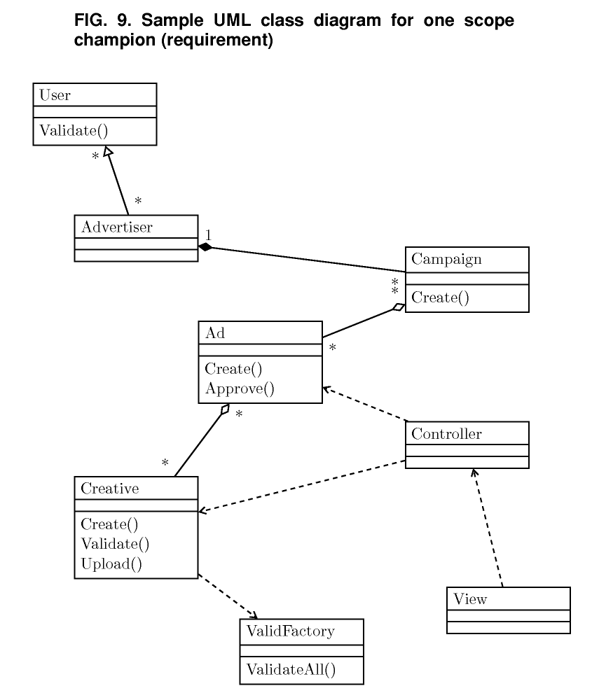

FIG. 9 is a simple UML [31] diagram created by a system analyst together with a software architect for one scope champion R4.7. The diagram includes classes to be used in the requirement implementation. The diagram is not complete and does not present the whole technical solution. There is just a number of the most important classes, that will be implemented.

During the development of such diagrams, working time of software architect (or some other technical specialist) is invested into more detailed investigation of the problem. Class diagram helps estimators to provide much more detailed and grounded data, than with estimating according to textual description of function requirement.

FIG. 10 shows a short sample protocol of estimation of the class diagram from FIG. 9. Classes are estimated together with methods.

The estimates were given by a sample estimator and it took around one hour to create a UML class diagram (FIG. 9) and also one hour to estimate the time required to implement the classes and methods. BC, WC and ML means the same as in FIG. 6, it's three-point estimate technique.

Thus, it will take about 10 15 hours to estimate the whole system, no matter how many requirements it has, besides the scope champions. It's clear that during this time it's impossible to analyze and estimate hundreds of requirements with the same accuracy and involvement.

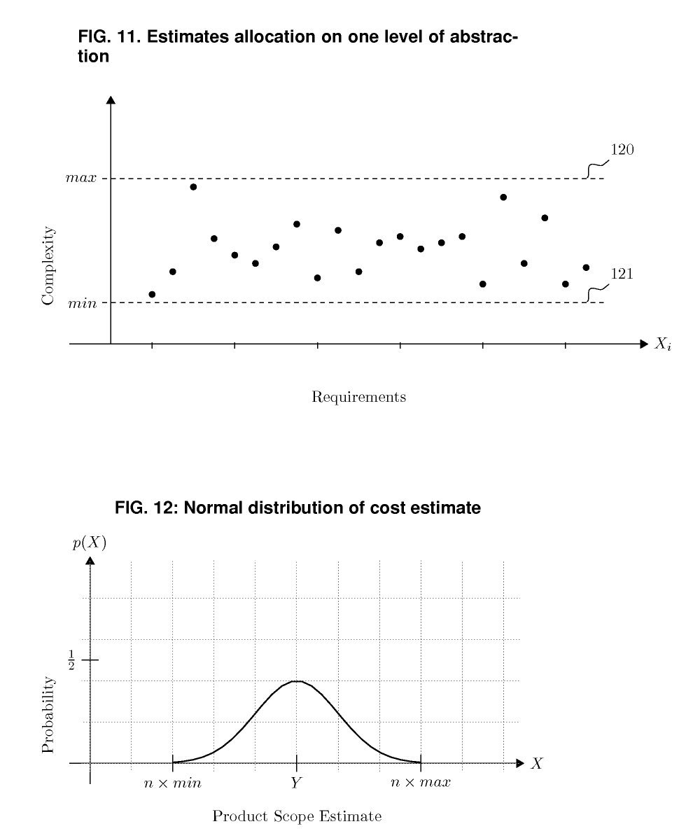

FIG. 11 illustrates the allocation of requirements, showing that estimates are random numbers distributed in the interval between min and max.

FIG. 12 shows the graph of probability distribution. Horizontal axis is an expected X, summary of all Xᵢ. Vertical axis is a probability of given X.

There is a simple mathematical explanation of the proposed invention, which is based on probability theory and Central Limit Theorem [23, pp. 317-323].

The estimated size X of the product scope is a summary of all individual estimates Xᵢ of functional requirements (n):

$$X = {\sum }_{i}^{n} {X}_{i} \qquad ( 2 )$$

It is assumed that the list of requirements consists of a complete set of elements on the same level of abstraction, see FIG. 8.

The set of requirements is complete if it covers the whole product scope and it is impossible to add any more requirements to it without changing the level of abstraction.

We assume that all individual estimates satisfy that criteria:

min<Xᵢ<max

min<Xᵢ<min×R (3)

R>1

Where R is a ratio-constant, that indicates there is a certain difference between maximum and minimum on the given level of abstraction.

We assume that all estimates Xᵢ are unbiased estimates of the mean μ, where μ equals to:

$$\begin{matrix}μ = \frac{max + min}{2} = \\ = max \times \frac{1 + R}{2 R} = \\ = max \times Z\end{matrix} \qquad ( 4 )$$

According to central limit theorem, the sum of all Xᵢ is an approximately, normally distributed value, i.e. following a “normal” distribution [33, pp. 152-154], see FIG. 12.

Since the estimates are unbiased, the sum of them is distributed normally, each estimate Xᵢ is in the interval [min . . . max], and max depends on min as defined in (3), we assume that the mean Y could be calculated like:

$$\begin{matrix}Y = μ \times n = \\ = max \times Z \times n\end{matrix} \qquad ( 5 )$$

Manually selecting a small number (m is less than seven) of functional requirements (which are the most complex, according to expert judgement), we estimate them: {Y₁, Y₂, . . . Yₘ}. Product scope estimate equals to:

$$\begin{matrix}max = \frac{1}{m} \times {\sum }_{i = 1}^{m} {Y}_{i} \\ Y = Z \times \frac{n}{m} \times {\sum }_{i = 1}^{m} {Y}_{i} \\ Z \approx 0.56\end{matrix} \qquad ( 6 )$$

The constant 0.56 was found experimentally and could be changed, according to the analysis of the requirements structure.

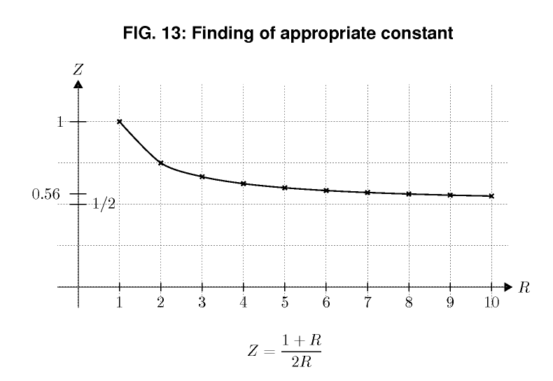

FIG. 13 illustrates the dependency between R (from equation 3) and the constant for equation 6. It is visually clear that the constant (Z) will be somewhere in interval (½; 1] and will never reach ½.

It is assumed that R will be not only bigger than 1, but also bigger than 5. In other words, the most complex requirement will be at least 5 times more complex than the smallest one. In most cases this is true and the value of 0.56 will be the best for any given software project.

However, it's possible to use any other constant in interval (½; 1], keeping it close to the lowest boundary (½).

### 5 US PATENT DOCUMENTS

| | | |
|---|---|---|
| 7,398,510 | July 2008 | Lake |
| 7,350,185 | March 2008 | Sparago, et al. |
| 7,213,234 | April 2003 | Paul A. Below |
| 6,219,654 | April 2001 | Michael Ruffin |
| 6,970,803 | November 2005 | Aerdts, et al. |
| 6,938,007 | August 2005 | Iulianello, et al. |
| 6,859,768 | February 2005 | Wakelam, et al. |
| 6,725,399 | April 2004 | Bowman |
| 6,715,130 | March 2004 | Eiche, et al. |
| 6,675,149 | January 2004 | Ruffin, et al. |
| 6,658,643 | December 2003 | Bera |
| 6,519,763 | February 2003 | Kaufer, et al. |
| 6,513,154 | January 2003 | Porterfield |
| 6,343,285 | January 2002 | Tanaka, et al. |
| 6,260,020 | July 2001 | Ruffin, et al. |
| 6,128,773 | October 2000 | Snider |
| 6,073,107 | August 1997 | Arlene F. Minkiewicz, et al. |
| 6,014,760 | January 2000 | Silva, et al. |
| 5,729,746 | March 1998 | Leonard |
| 11/439,606 | May 2006 | Renjeev V. Kolanchery, et al. |
| 9/904,644 | July 2001 | William H. Roetzheim |

### REFERENCES

[1] A. J. Albrecht and J. E. Gaffney. Software function, source lines of code, and development effort prediction: A software science validation. IEEE Transactions on Software Engineering, 9(6):639-648, November/December 1983.
[2] Kent Beck and Martin Fowler. Planning Extreme Programming. Addison-Wesley, 2000.
[3] Barry Boehm. Software Engineering Economics. Englewood Cliffs, Prentice-Hall, 1981.
[4] Carnegie Melon, Software Engineering Institute. CMMI for Development, Version 1.2, CMU/SEI-2006-TR-008, 2006.
[5] Betty H. C. Cheng and Joanne M. Atlee. Research directions in requirements engineering. In FOSE '07: 2007 Future of Software Engineering, pages 285-303, Washington, D.C., USA, 2007. IEEE Computer Society.
[6] Alistair Cockburn. Writing effective use cases. Addison-Wesley, 2000.
[7] Alistair Cockburn. Agile Software Development. Addison-Wesley, 2001.
[8] Judith Crow and Ben Di Vito. Formalizing space shuttle software requirements: four case studies. ACM Trans. Softw. Eng. Methodol., 7(3):296-332, 1998.
[9] Barry Boehm et al. Software Cost Estimation with Cocomo II. Addison-Wesley, 2000.
[10] Vincenzo Gervasi and Didar Zowghi. Reasoning about inconsistencies in natural language requirements. ACM Trans. Softw. Eng. Methodol., 14(3):277-330, 2005.
[11] IBM. Rational Unified Process in Rational Method Composer, 2007.
[12] Project Management Institute. Project Management Body of Knowledge (PMBOK) Guide v.3. PMI Press, 3rd edition, 2004.
[13] The Institute of Electrical and Electronics Engineers. IEEE 1028-1997 Standard for Software Reviews, 1997.
[14] The Institute of Electrical and Electronics Engineers. IEEE 1016-1998 Recommended Practice for Software Design Descriptions, 1998.
[15] The Institute of Electrical and Electronics Engineers. IEEE 829-1998 Standard for Software Test Documentation, 1998.
[16] The Institute of Electrical and Electronics Engineers. IEEE 830-1998 Recommended Practices for Software Requirements Specification, 1998.
[17] The Institute of Electrical and Electronics Engineers. IEEE 1471-2000 Recommended Practice for Architectural Description of Software-Intensive Systems, 2000.
[18] International Organization for Standardization. ISO 20926, Software Engineering—IFPUG 4.1 Unadjusted functional size measurement method—Counting practices manual, 2003.
[19] Hemant Jain, Padmal Vitharana, and Fatemah “Mariam” Zahedi. An assessment model for requirements identification in component-based software development. SIGMIS Database, 34(4):48-63, 2003.
[20] Ralph D. Jeffords and Constance L. Heitmeyer. A strategy for efficiently verifying requirements. SIGSOFT Softw. Eng. Notes, 28(5) :28 37, 2003.
[21] S. Kanmani, Jayabalan Kathiravan, S. Senhil Kumar, and Mourougane Shanmugam. Class point based effort estimation of oo systems using fuzzy subtractive clustering and artificial neural networks. In ISEC '08: Proceedings of the 1st conference on India software engineering conference, pages 141-142, New York, N.Y., USA, 2008. ACM.
[22] Lo Kwun Kit, Chan Kwun Man, and Elisa Baniassad. Isolating and relating concerns in requirements using latent semantic analysis. SIG-PLAN Not., 41(10):383-396, 2006.
[23] Achim Klenke. Probability Theory, Comprehensive Course. Springer, Mainz, Germany, 2006.
[24] Seok Won Lee and David C. Rine. Missing requirements and relationship discovery through proxy viewpoints model. In SAC '04: Proceedings of the 2004 ACM symposium on Applied computing, pages 1513-1518, New York, N.Y., USA, 2004. ACM.
[25] Annabella Loconsole. Empirical studies on requirement management measures. In ICSE '04: Proceedings of the 26th International Conference on Software Engineering, pages 42-44, Washington, D.C., USA, 2004. IEEE Computer Society.
[26] Neil Maiden, Alexis Gizikis, and Suzanne Robertson. Provoking creativity: Imagine what your requirements could be like. IEEE Software, 21(5):68-75, 2004.
[27] Neil Maiden, Sharon Manning, Suzanne Robertson, and John Greenwood. Integrating creativity workshops into structured requirements processes. In DIS '04: Proceedings of the 5th conference on Designing interactive systems, pages 113-122, New York, N.Y., USA, 2004. ACM.
[28] Steve McConnell. Software Estimation, Demistifying the Black Art. Microsoft Press, Redmond, 2006.
[29] Parastoo Mohagheghi, Bente Anda, and Reidar Conradi. Effort estimation of use cases for incremental large-scale software development. In ICSE '05: Proceedings of the 27th international conference on Software engineering, pages 303-311, New York, N.Y., USA, 2005. ACM.
[30] Bashar Nuseibeh and Steve Easterbrook. Requirements engineering: a roadmap. In ICSE '00: Proceedings of the Conference on The Future of Software Engineering, pages 35-46, New York, N.Y., USA, 2000. ACM.
[31] Object Management Group. Unified Modeling Language (UML), Superstructure, Version 2.0, 2005.
[32] Vili Podgorelec and Marjan Hericko. Estimating software complexity from uml models. SIGSOFT Softw. Eng. Notes, 32(2):1-5, 2007.
[33] Alfred Renyi. Probability Theory. Dover Publications Inc., New York, USA, 2007.
[34] M. Shepperd and C. Schofield. Estimating software project effort using analogies. IEEE Transactions on Software Engineering, 23(11):736-743, November 1997.
[35] Adam Trendowicz, Jens Heidrich, Jürgen Münch, Yasushi Ishigai, Kenji Yokoyama, and Nahomi Kikuchi. Development of a hybrid cost estimation model in an iterative manner. In ICSE '06: Proceedings of the 28th international conference on Software engineering, pages 331-340, New York, N.Y., USA, 2006. ACM.
[36] Karl Wiegers. Peer reviews in software: a practical guide. Addison-Wesley, Indianapolis, US, 2002.
[37] Karl Wiegers. Software Requirements, Thorny Issues and Practical Advise. Microsoft Press, Redmond, 2nd edition, 2003.

1. A method for project estimation comprising:
1. defining project scope with scope definition, containing numbered requirements, on the same level of abstraction;
2. selecting a limited number of requirements, called scope champions, which are the most complex;
3. estimating the selected scope champions, using estimating procedure;
4. calculating project scope estimate as a sum of all scope champion estimates, multiplied by total amount of requirements, divided by total amount of scope champions and multiplied by constant.

2. The method according to claim 1, wherein the project is at least one of a software development project, a software product, a software component and a document.

3. The method according to claim 1, wherein said defining includes regrouping requirements, until they reach the same level of abstraction;

4. The method according to claim 1, wherein said selecting includes at least one of selecting with expert judgement and selecting with selection method, defined elsewhere.

5. The method according to claim 1, wherein the requirement is at least one of a functional requirement, a non-functional requirement, a test case, a design element, a diagram, and a use case.

6. The method according to claim 1, wherein the constant is at least one of a 0.56, another constant, and a result of function, calculated elsewhere.

7. The method according to claim 1, wherein the procedure is at least one of a three-point estimate, a function point estimate, and another estimating method.
